(19) United States
(12) Patent Application Publication
(10) Pub. No.: US 2007/0145104 A1
(43) Pub. Date: Jun. 28, 2007

(54) System and method for advanced solder bumping using a disposable mask

(76) Inventors: Mengzhi Pang, Phoenix, AZ (US); Islam A. Salama, Chandler, AZ (US)

Correspondence Address: Buckley, Maschoff & Talwalkar LLC;Attorneys for INTEL Corporation, Five Elm Street, New Canaan, CT, 06840, US

(21) Appl. No.: 11/320,021

(22) Filed: Dec. 28, 2005

(51) Int. Cl. B23K 31/02; B23K 1/08

(52) U.S. Cl. 228/180.22; 228/39

(57) ABSTRACT

According to some embodiments, a process, an apparatus, and a system are provided. In some embodiments, the process includes reflowing solder located in an opening formed through both a solder resist material disposed on a substrate and a mask material disposed on top of the solder resist material; and removing the mask material after reflowing of the solder.

### BACKGROUND

Flip chips, including “Controlled Collapse Chip Connection” (C4) technology, may offer a proven standard interconnect technology for a number of applications including, for example, microprocessors and portable/mobile applications. To address these and additional potential applications, there is a desire to decrease bump pitch for high I/O and high power chips. The push for reduced bump pitch may result in corresponding decreases in via size opening, bump size, bump height, etc. To adequately address many potential applications, an understanding of IC package design and processing, including an understanding of materials and process flows may be needed.

Reliability of a flip chip may be impacted by the construction of the solder bumps and other assembly factors, including understanding and controlling the systems and methods to create the solder bumps. Variations in a bumping process or aspects thereof may result in a failure and/or reduced reliability of a flip chip device.

### BRIEF DESCRIPTION OF THE DRAWINGS

FIG. 1 is a flow chart of an exemplary process, in accordance with some embodiments herein;

FIG. 2 is another flow chart of an exemplary process, in accordance with some embodiments herein;

FIGS. 3A-3F are exemplary illustrations of an apparatus, at various stages of a manufacturing process, according to some embodiments hereof; and

FIGS. 4 is an exemplary illustration of a system, according to some embodiments hereof.

### DETAILED DESCRIPTION

The several embodiments described herein are solely for the purpose of illustration. Embodiments may include any currently or hereafter-known versions of the elements described herein. Therefore, persons in the art will recognize from this description that other embodiments may be practiced with various modifications and alterations.

Some embodiments hereof provide a manufacturing process for producing a flip chip package. In some embodiments, the flip chip is formed using a wafer substrate that has a conductive solder bump formed in an opening in solder resist material disposed on a surface of the substrate. In a process of forming the solder bump, a mask material is removed after a reflow process of solder, in accordance with some embodiments herein.

Removing the mask material after the reflow of the solder may provide solder bumps that have an improved consistency in features such as height, as compared to solder bumps creating using a bumping process wherein the mask material is removed prior to the solder reflow process. In some embodiments, removal of the mask material after the reflow process eliminates or reduces mask lift-off of solder during the manufacturing process.

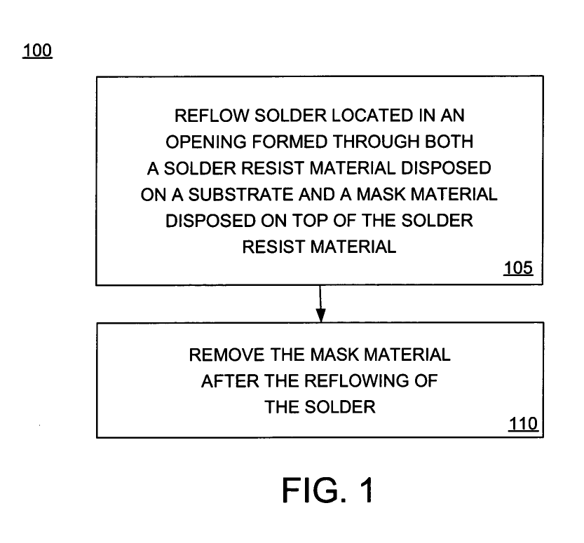

Referring to FIG. 1, there is shown an exemplary flow diagram of a manufacturing process for producing an apparatus in accordance with some embodiments hereof, generally represented by the reference numeral 100. Processes herein, including process 100, may be performed by any combination of hardware, software, and/or firmware. According to some embodiments, instructions for implementing processes, including but not limited to process 100, may be stored in executable code. The code may be stored on any suitable article or medium that is or becomes known.

At operation 105, a solder reflow process is performed. Solder located in an opening formed through both a solder resist material disposed on a substrate and a mask material disposed on top of the solder resist material is reflowed. The reflow of the solder may be accomplished by subjecting the solder to temperatures sufficient to reflow the solder. In some embodiments, the opening may be a solder resist opening.

It should be appreciated that the temperature needed to reflow the solder may vary, depending for example on the chemical composition of the solder. Those skilled in the relevant arts should appreciate this aspect of IC manufacturing. Accordingly, a discussion of specific solder materials and corresponding reflow temperatures are not included herein.

Proceeding to operation 110 of process 100, the mask material is removed. It is noted that the mask material is removed after the reflow of the solder. Thus, the solder bump is formed prior to a removal of the mask material. In this manner, process 100 reduces or avoids lifting-off solder during the removal of the mask material. By controlling the quantity of solder provided for the reflow process and removing the mask material after the reflow of the solder, the consistency or uniformity of the solder bumps formed by process 100 may be maintained.

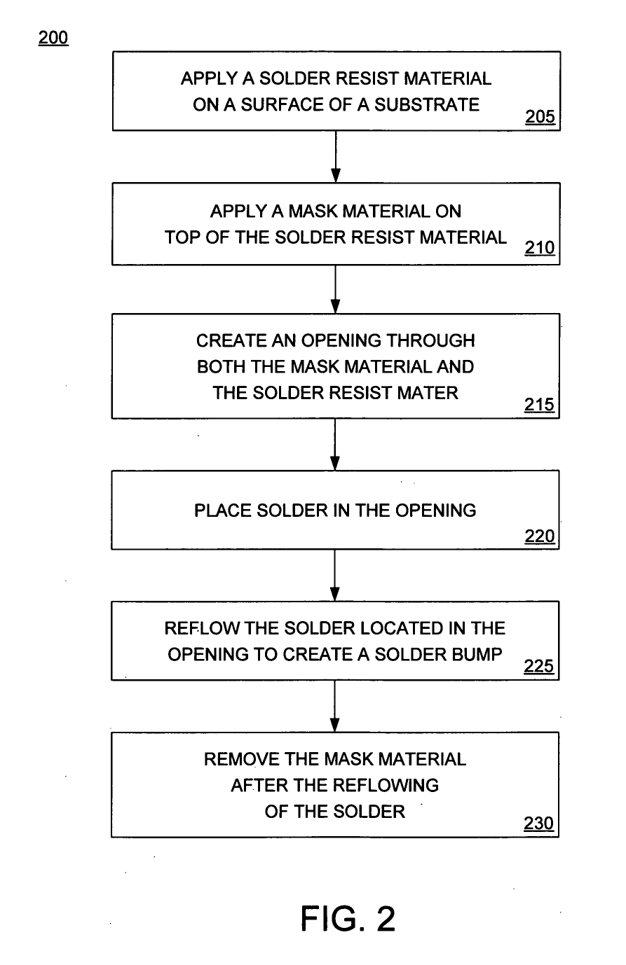

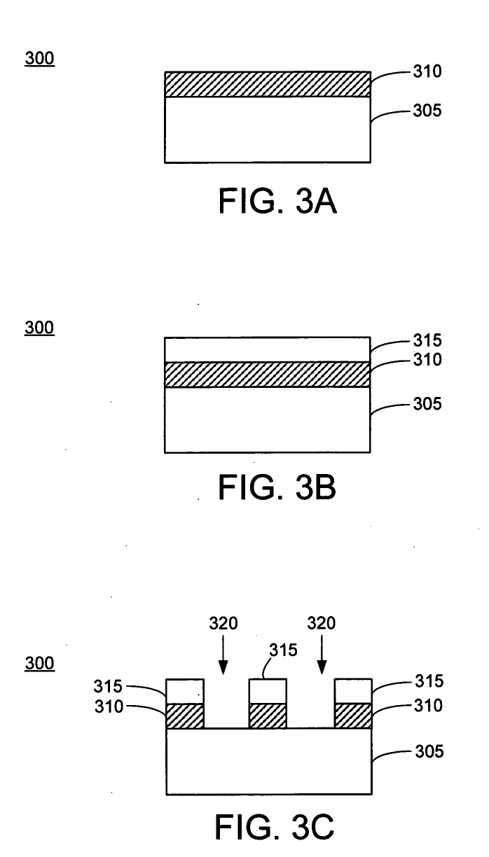

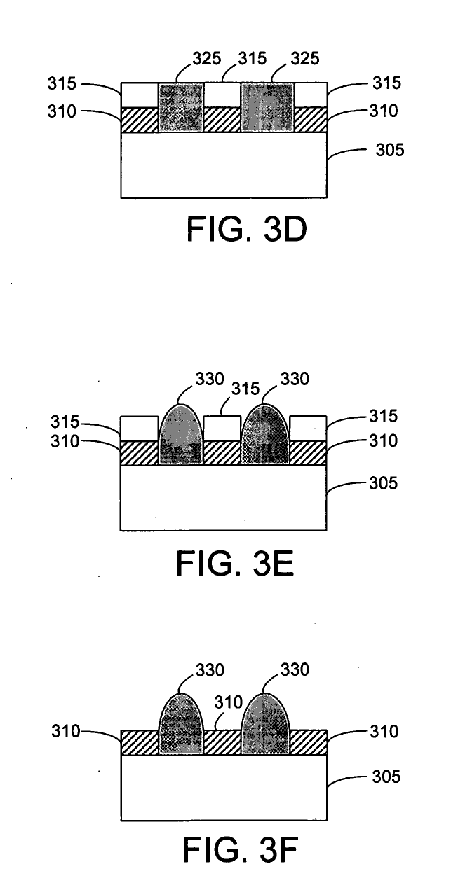

FIG. 2 provides an exemplary flow chart in accordance with some embodiments herein. The process of FIG. 2 is generally referenced by numeral 200. Process 200 may be further understood by also referring to FIGS. 3A-3F in conjunction with the following discussion of the flow chart of FIG. 2.

At operation 205, a wafer including a substrate having solder resist material on a first surface of the substrate is created, obtained, or otherwise provided for use in process 200. The substrate may be produced or formed using any number of methods and techniques of IC (integrated circuit) manufacturing processes that result in a substrate suitable and compatible with the various aspects and embodiments herein. FIG. 3A provides an exemplary illustration of a substrate 305 described at 105, including solder resist material 310 on a top surface of the substrate. In some embodiments, solder resist material 310 may include one or more layers of solder resist material(s).

In some embodiments, substrate 305 may include a single or multilayer dielectric material. The dielectric material may be selected to include any number of materials compatible with and suitable for IC manufacturing processes, not limited to those explicitly discussed herein. Furthermore, those skilled in the art are familiar with the range of substrate materials compatible with the various embodiments herein. In some embodiments, substrate 305 may include build-up layers of ABF (Ajinomoto Build-Up Film) or other organic film layer.

At 210, the substrate is processed to apply a mask material on top of the solder resist material. The wafer is processed through an IC manufacturing flow, conventional or otherwise, to pattern mask material on top of the solder resist material. The bi-layer of solder resist material and mask material is applied to at least a portion of a surface of the substrate. That is, the bi-layer of solder resist material and mask material may be selectively applied to the substrate in a desired pattern. The pattern of application for the bi-layer may be varied depending on a particular IC manufacturing flow, application, and use for wafer 300.

FIG. 3B illustratively depicts wafer 300 having a patterned mask material 315 applied thereto. As shown, substrate 305 has the solder resist material 310 applied thereto, as well as the mask material 315 on top of the solder resist material. Mask material 315 is shown placed on top of solder resist material 310.

At operation 215, an opening is created through both the solder resist material and the mask material. The opening may be removed using a number of chemical and/or mechanical methods and techniques. In some embodiments, a laser projection patterning (LPP) technique may be used to drill through the solder resist material and the mask material. According to some LPP techniques, a laser beam at a predetermined wavelength may be used to irradiate the solder resist material and the mask material to ablate therethrough to a desired depth. In some embodiments, the desired depth corresponds to a depth that extends down through the solder resist material and the mask material to a solder bump pad (e.g., a bump site).

Referring to FIG. 3C, an opening 320 is created through both solder resist material 310 and mask material 315. Two openings 320 are shown in FIG. 3C, however one, two, or more openings may be provided. Opening 320 may be through both solder resist material 310 and mask material 315 to a depth that extends down to a solder bump pad (e.g., a bump site).

In some embodiments, opening 320 may extend down through both solder resist material 310 and mask material 315 to an under bump metallization (UBM) layer (not shown) and/or other material.

At operation 220, as illustrated in FIG. 3D, solder 325 is placed in the opening created through both solder resist material 310 and mask material 315. In some embodiments, solder 325 may be placed into opening 320 using a solder printing technique to place a solder paste into the opening. It should be appreciated that solder 325 should be compatible with IC manufacturing processes and the various embodiments herein, and may be placed into the opening through both solder resist material 310 and mask material 315 in a variety of methods and techniques.

At operation 225, as illustrated in FIG. 3E, solder 325 is subjected to a reflow process to create a solder bump 330 in the opening formed through both solder resist material 310 and mask material 315. In some embodiments, solder bump 330 may have a substantially spherical upper surface. Sidewalls of opening 320 may act to contain solder 325 therebetween during the reflow process.

At operation 230, as illustrated ion FIG. 3F, mask material 315 is removed from the top of solder resist material 310. Removal of mask material 315 after the reflow process of operation 225 reduces or eliminates potential lift-off of solder material 325 that may otherwise occur in an instance the mask material were removed prior to the reflow process. In some embodiments, the removal of mask material 315 may be accomplished using a chemical technique, a laser ablation technique, a mechanical technique, and combinations thereof.

In some embodiments herein, removal of mask material after the reflow process to create solder bump provides facilitates a mechanism for providing consistent or uniform solder bumps. By controlling the size of the opening, the amount of solder placed in the opening, and removing mask material after the reflow process, the amount of solder subjected to the reflow process may be consistently maintained. Thus, consistent or uniform solder bumps may be provided in accordance with some of the embodiments herein.

In some embodiments, the height of the solder bumps created in accordance with some embodiments herein may vary about 5 micrometers (μm) or less.

In some embodiments herein, the opening created through both the solder resist material and the mask material is done substantially at the same time. For example, the opening through both the solder resist material and the mask material may be made using a single laser beam in a LPP process. Other methods, techniques, and processes may be used to create the opening through both the solder resist material and the mask material. In this manner, alignment of the opening through the solder resist material and the opening through the mask material may coincide. That is, the opening through both the solder resist material and the mask material may be coincident through the different materials.

In some embodiments, the opening through both of the solder resist and mask materials may be made at the same time to achieve alignment of the opening through the various layers (e.g., solder resist material, mask material) of the opening. In some embodiments, an alignment tolerance of about 5 um or less may be achieved by making the opening through the various layers at the same time.

In some embodiments herein, the mask material is not constructed of a photosensitive material. For example, in some embodiments herein the mask material is removed using a laser beam. Accordingly, the mask material need not be photosensitive to effectuate an etching processing that depends on the photosensitivity of the mask material.

In some embodiments herein, the mask material (e.g., 315) is a disposable mask material. As such, a cost savings may be realized by some of the methods, apparatuses, and systems herein. For example, the mask material may not have certain properties needed in other IC manufacturing processes such as, for example, photosensitivity, etc. Disposable mask materials compatible with some embodiments herein may include, for example, dry film resist.

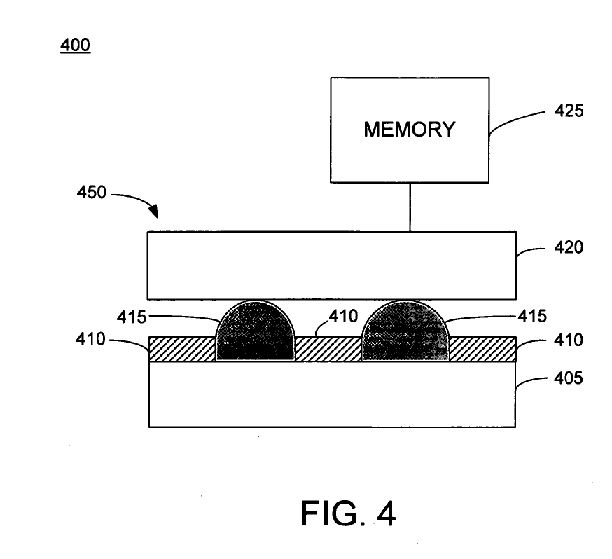

FIG. 4 is an exemplary depiction of a system 400 including an apparatus, for example a flip chip IC package 450, having solder bumps 415 created in accordance with some embodiments herein. Flip chip 450 may be connected to a memory 425. Those in the art should appreciate that system 400 may include additional, fewer, or alternative components to flip chip 450 and memory 425. Memory 425 may comprise any type of memory for storing data, including but not limited to a Single Data Rate Random Access Memory, a Double Data Rate Random Access Memory, or a Programmable Read Only Memory.

In some embodiments, IC device 420 is placed in contact with solder bumps 415. IC device 420 may contact solder bumps 415 at conductive connectors, pads, and traces (not shown) to provide electrical connectivity between IC device 420 and substrate 405, through solder bumps 415. In some embodiments, an apparatus, system, and device may include solder bumps 420 created by removing a mask material (not shown) (e.g., a disposable mask material) previously disposed on top of solder resist material 410 and subsequently removed therefrom after a reflow process used to create solder bumps 420.

It should be appreciated that the drawings herein are illustrative of various aspects of the embodiments herein, not exhaustive of the present disclosure. For example, FIGS. 3 and 4 are simplified for considerations of clarity. While not shown, it should be appreciated that FIGS. 3 and 4 may include under bump metallization (UBM), underfill materials, and other flip chip components and attributes.

The several embodiments described herein are solely for the purpose of illustration. Persons in the art will recognize from this description that other embodiments may be practiced with modifications and alterations limited only by the claims.

What is claimed is:

1. A process comprising:
reflowing solder located in an opening formed through both a solder resist material disposed on a substrate and a mask material disposed on top of the solder resist material; and
removing the mask material after the reflowing of the solder.

2. The method of claim 1, wherein the mask material comprises a disposable mask material.

3. The method of claim 1, wherein the solder resist material is not photosensitive.

4. The method of claim 1, wherein the opening is about 70 micrometers (μm) or less in diameter.

5. The method of claim 1, further comprising:
reflowing solder located in a plurality of openings formed through both the solder resist material and the mask material to create a plurality of solder bumps; and
removing the mask material after the reflowing of the solder in the plurality of openings.

6. The method of claim 5, wherein in a wherein a variance in height for the plurality of solder bumps is about 10 μm or less.

7. The method of claim 6, wherein the variance in height is about 5 μm or less.

8. The method of claim 1, wherein the opening through both the solder resist material and the mask material is created by irradiating both the solder resist material and the mask material using a laser beam.

9. The method of claim 1, wherein the solder is placed in the opening by a solder paste printing process.

10. The method of claim 1, wherein the removing of the mask material is accomplished using at least one of a chemical technique and a laser ablation technique.

11. The method of claim 1, further comprising at least one of:
applying a solder resist material on the surface of the substrate, applying the mask material on top of the solder resist material, placing the solder in the solder resist opening, and combinations thereof.

12. An apparatus comprising:
a substrate;
at least one layer of solder resist material on a surface of the substrate; and
a solder bump, wherein the solder bump is created by:
applying at least one layer of mask material on top of the solder resist material;
subjecting solder placed in an opening through both the at least one layer of solder resist material and the at least one layer of mask material to a reflow process; and
removing the mask material from at least an area adjacent to the solder bump after reflowing the solder in the reflow process.

13. The apparatus of claim 12, wherein, wherein the mask material comprises a disposable mask material.

14. The apparatus of claim 12, wherein the solder resist material is not photosensitive.

15. The apparatus of claim 12, wherein the opening is about 70 micrometers (μm) or less in diameter.

16. The apparatus of claim 12, further comprising:
a plurality of solder bumps in a plurality of openings formed through both the solder resist material and the at least one layer of mask material, wherein the at least one layer of mask material is removed after reflowing of the solder in the reflow process.

17. The apparatus of claim 16, wherein in a wherein a variance in height for the plurality of solder bumps is about 10 μm or less.

18. The apparatus of claim 17, wherein the variance in height is about 5 μm or less.

19. The apparatus of claim 12, wherein the opening through both the solder resist material and the mask material is created by irradiating both the solder resist material and the mask material using a laser beam.

20. The apparatus of claim 12, wherein the solder is placed in the opening by a solder paste printing process.

21. The apparatus of claim 12, wherein the removing of the mask material is accomplished using at least one of a chemical technique and a laser ablation technique.

22. A system comprising:
a substrate;
at least one layer of solder resist material on a surface of the substrate; and
a solder bump, wherein the solder bump is created by:
applying at least one layer of mask material on top of the solder resist material;
subjecting solder placed in an opening through both the at least one layer of solder resist material and the at least one layer of mask material to a reflow process; and
removing the mask material from at least an area adjacent to the solder bump after reflowing the solder in the reflow process;
an integrated circuit (IC) device attached to the solder bump; and
a memory, wherein the memory is a Double Data Rate Random Access Memory.

23. The system of claim 22, wherein the solder resist opening is about 70 micrometers (μm) or less in diameter.

24. The system of claim 22, wherein the IC is a microprocessor.
